(19) United States
(12) Patent Application Publication
(10) Pub. No.: US 2014/0246878 A1
(43) Pub. Date: Sep. 4, 2014

(54) VEHICLE DOOR FRAME STRUCTURE

(71) Applicant: SHIROKI CORPORATION, Fujisawa-shi (JP)

(72) Inventors: Kenji Shimizu, Fujisawa-shi (JP); Shigenobu Ohsawa, Fujisawa-shi (JP)

(73) Assignee: SHIROKI CORPORATION, Fujisawa-shi (JP)

(21) Appl. No.: 14/350,148

(22) PCT Filed: Oct. 3, 2012
(86) PCT No.: PCT/JP2012/075596

§ 371 Date: Apr. 7, 2014

(30) Foreign Application Priority Data
Oct. 7, 2011 (JP) 2011-222719

(51) Int. Cl. B60J 5/04

(52) U.S. Cl. CPC B60J 5/0402
USPC 296/146.2

(57) ABSTRACT

A door frame structure is achieved, which is applicable to a plurality of vehicle doors for different specifications and capable of being commonalized as much as possible.

A door frame structure, applicable to a plurality of vehicle doors for different specifications, includes first and second door sash bodies, in which only design portions thereof are mutually different, the first and second door sash bodies each including a pocket-shaped portion, a weather-strip holding groove and a glass-run holding groove, wherein the pocket-shaped portion, the weather-strip holding groove and the glass-run holding groove of the first door sash body and the pocket-shaped portion, the weather-strip holding groove and the glass-run holding groove of the second door sash body have a common cross-sectional shape, respectively; and an additional molding which is mounted onto the design portion of the first door sash body, without being mounted onto the design portion of the second door sash body. The first door sash body, to which the additional molding is mounted, is used for a door of one specification and the second door sash body is used for a door of another specification.

### TECHNICAL FIELD

The present invention relates to a vehicle door frame structure.

### BACKGROUND ART

Door sash portions of vehicle door frames have been classified into the following types: a general type (e.g., a black type) and a high-grade type (e.g., lustrous type) in accordance with the grade within the same vehicle model. The design portion of the door sash body is colored black by coating, surface treatment, or tape application, etc., in the black type, whereas an independent lustrous molding (additional molding) that includes a stainless steel material is mounted onto the design portion of the door sash body in the lustrous type.

### CITATION LIST

### Patent Literature

Patent Literature 1: Japanese Unexamined Patent Publication No. 2006-213184

### SUMMARY OF INVENTION

### Technical Problem

Conventionally, door frames (door sashes) for luxury vehicles having such an additional molding and door frames (door sashes) for general vehicles which do not include such an additional molding are individually designed, and accordingly, no concept of communalization has existed between these types of door frames (door sashes).

### Solution to Problem

The present invention has been accomplished based on the findings that door frames for different specifications of the same vehicle model, in particular, are mutually identical in basic shape and are capable of being commonalized, except for the design portions. Although the present invention has been made directly as a result of consideration of door frames for different specifications of the same vehicle model, the present invention can also be applied to a plurality of vehicle doors simply for different specifications (of different vehicle models), even not of the same vehicle model.

In the present invention a door frame structure is provided, which is applicable to a plurality of vehicle doors for different specifications, the door frame structure including first and second door sash bodies, in which only design portions thereof are mutually different, the first and second door sash bodies each including a pocket-shaped portion, a weather-strip holding groove and a glass-run holding groove, wherein the pocket-shaped portion, the weather-strip holding groove and the glass-run holding groove of the first door sash body and the pocket-shaped portion, the weather-strip holding groove and the glass-run holding groove of the second door sash body have a common cross-sectional shape, respectively; and an additional molding which is mounted onto the design portion of the first door sash body, without being mounted onto the design portion of the second door sash body. The first door sash body, to which the additional molding is mounted, is used for a door of one specification and the second door sash body is used for a door of another specification.

In an embodiment, the design portion of the first door sash body and the design portion of the second door sash body are mutually different in width in cross section.

It is desirable for a clearance between a design portion of the additional molding of the first door sash body and a body opening and a clearance between the design portion of the second door sash body and the body opening to be the same, especially in the case where the additional molding is selected for vehicles having different specifications of identical vehicle models which have body openings of a same shape.

It is practical for weather strips having a same cross sectional shape to be held in weather-strip holding grooves of the first door sash body and the second door sash body, respectively, and glass runs having a same cross sectional shape to be held in glass-run holding grooves of the first door sash body and the second door sash body, respectively.

It is desirable for each of the glass runs to include an exposed portion which is exposed toward the design portion of the door sash body. With respect to the first door sash body, the glass-run exposed portion is spaced from a window-opening side end of the design portion of the first door sash body. The spacing and a vehicle exterior side surface of the glass-run exposed portion are covered by the additional molding. With respect to the second door sash body, the glass-run exposed portion is in elastic contact with a window-opening side end of the design portion of the second door sash body.

The additional molding mounted onto the design portion of the first door sash body includes, specifically, a molding body engaged onto both ends of the first door sash body in the width direction of the design portion, and a resin molding portion having an overlaying portion positioned on a window-opening side end of the molding body and a resin design lip portion extending from the overlaying portion toward the window opening. Due to the resin design lip portion of the resin molding portion, the vehicle-exterior surface of the glass-run exposed portion can be covered.

In a state where the additional molding is mounted onto the first door sash body, after the glass run is fitted in the glass-run holding groove, the additional molding can be mounted onto the design portion of the first door sash body by forming a clearance between the molding body and the glass-run exposed portion.

In an embodiment of the present invention, a group of vehicles, are provided, of a same vehicle model in which a door frame structure is applied to a plurality of vehicle doors for different specifications of the same vehicle model, the door frame including first and second door sash bodies, in which only design portions thereof are mutually different, the first and second door sash bodies each including a pocket-shaped portion, a weather-strip holding groove and a glass-run holding groove, wherein the pocket-shaped portion, the weather-strip holding groove and the glass-run holding groove of the first door sash body and the pocket-shaped portion, the weather-strip holding groove and the glass-run holding groove of the second door sash body have a common cross-sectional shape, respectively; and an additional molding which is mounted onto the design portion of the first door sash body, without being mounted onto the design portion of the second door sash body. The first door sash body is used for a vehicle door for one specification, and the second door sash body and the additional molding are used for a vehicle door for another specification.

### Advantageous Effects of Invention

According to the present invention, a door frame structure applicable to a plurality of vehicle doors for different specifications can be provided simply by preparing the first door sash body and the second door sash body, which are made different from each other only in regard to the shape of the design portion thereof, and the additional molding, which is mounted only onto the design portion of the first door sash body.

### BRIEF DESCRIPTION OF DRAWINGS

FIG. 1 is a cross sectional view of a first door sash body, showing an embodiment of a vehicle door frame structure according to the present invention;

FIG. 2 is a cross sectional view, including the first door sash body shown in FIG. 1, of the embodiment of the vehicle door frame structure according to the present invention, taken along the line II-II shown in FIG. 6;

FIG. 3 is a cross sectional view of a second door sash body, showing the embodiment of the vehicle door frame structure according to the present invention;

FIG. 4 is a cross sectional view, including the second door sash body shown in FIG. 3, of the embodiment of the vehicle door frame structure according to the present invention, taken along the line II-II shown in FIG. 6;

FIG. 5 is a cross sectional view of the first door sash body shown in FIG. 1 and the second door sash body shown in FIG. 3, illustrated in a superimposed state; and

FIG. 6 is a side view of a vehicle to which the vehicle door frame structure according to the present invention has been applied.

### DESCRIPTION OF EMBODIMENT

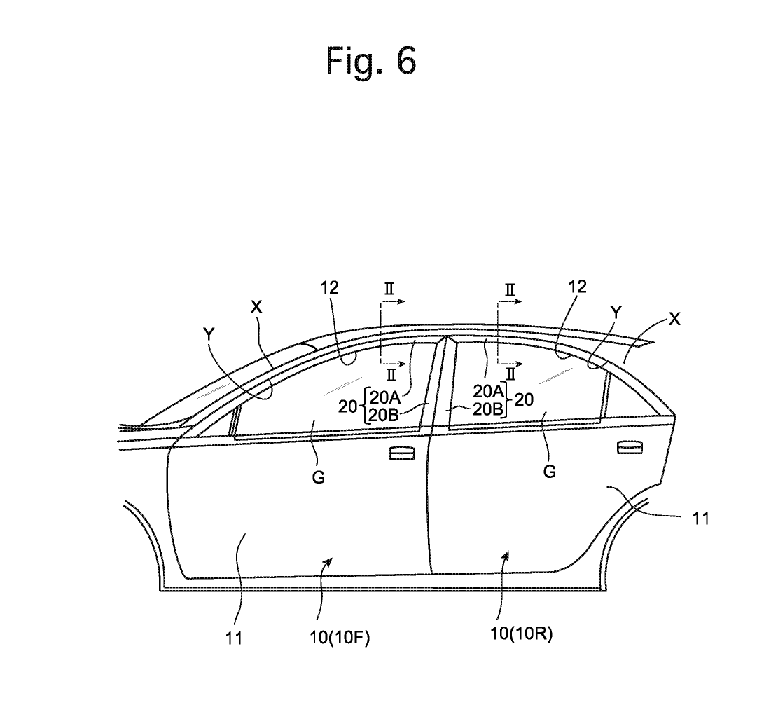

FIG. 6 shows aside shape of a vehicle to which the vehicle door frame structure according to the present invention is applied. Vehicle doors 10 that open and close body openings (door openings) Y of a vehicle body X are each provided on top of a door body (an inner panel and an outer panel) 11 with a door sash (window frame) 20, which forms a window opening 12. The door sash 20 is formed as a roll-formed product made of an iron-based material and is provided with an upper sash 20A which is curved in a side view to receive the upper edge of a window pane G and a vertical pillar sash 20B which receives the vertical edge of the window pane G. The present embodiment is applicable to both the upper sash 20A and the vertical pillar sash 20B and also to both a front door 10F and a rear door 10R.

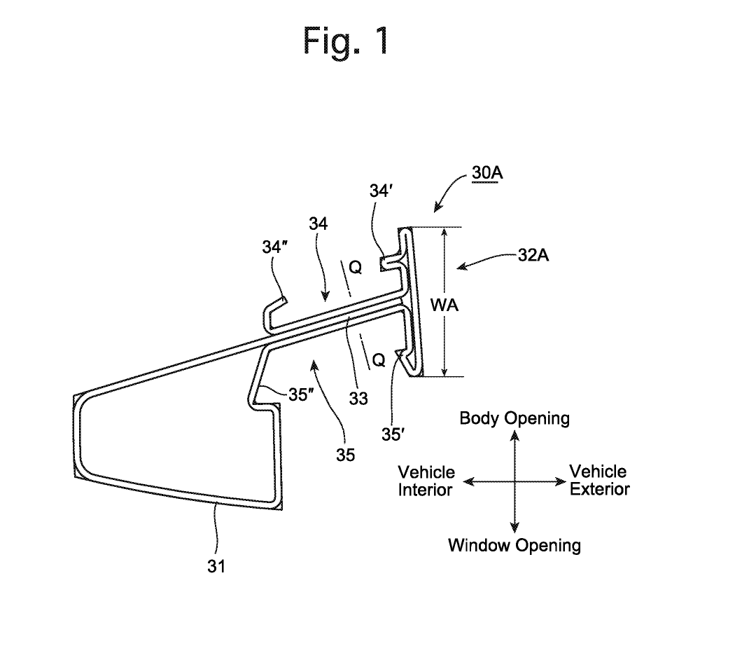

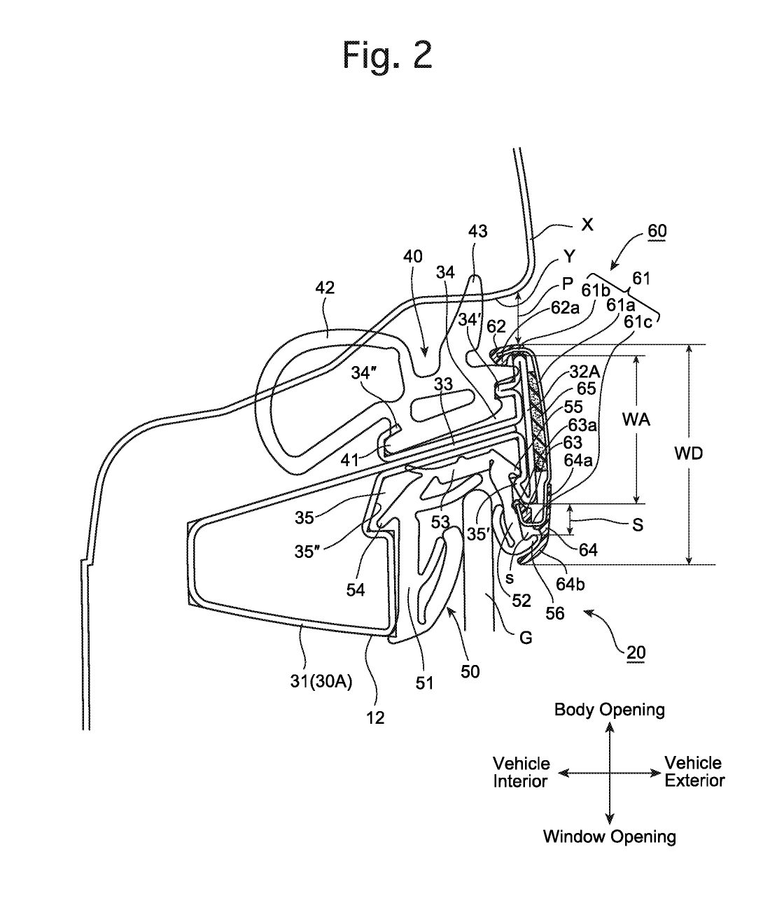

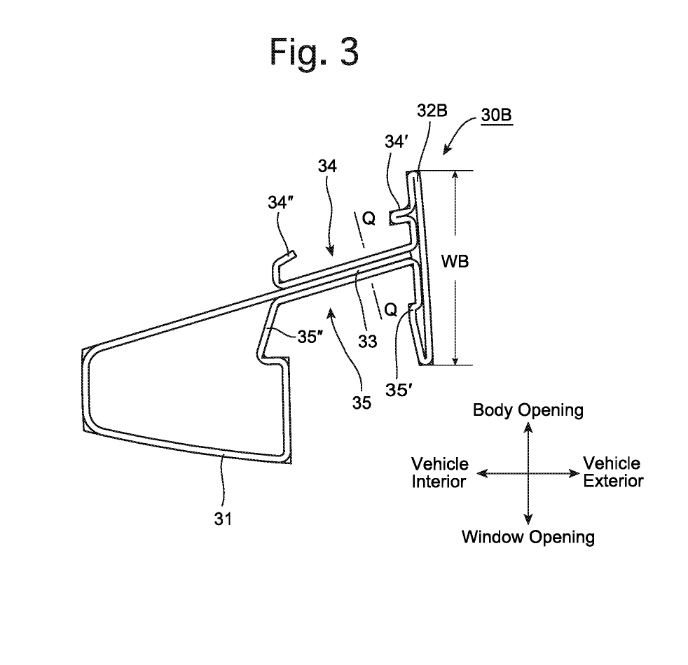

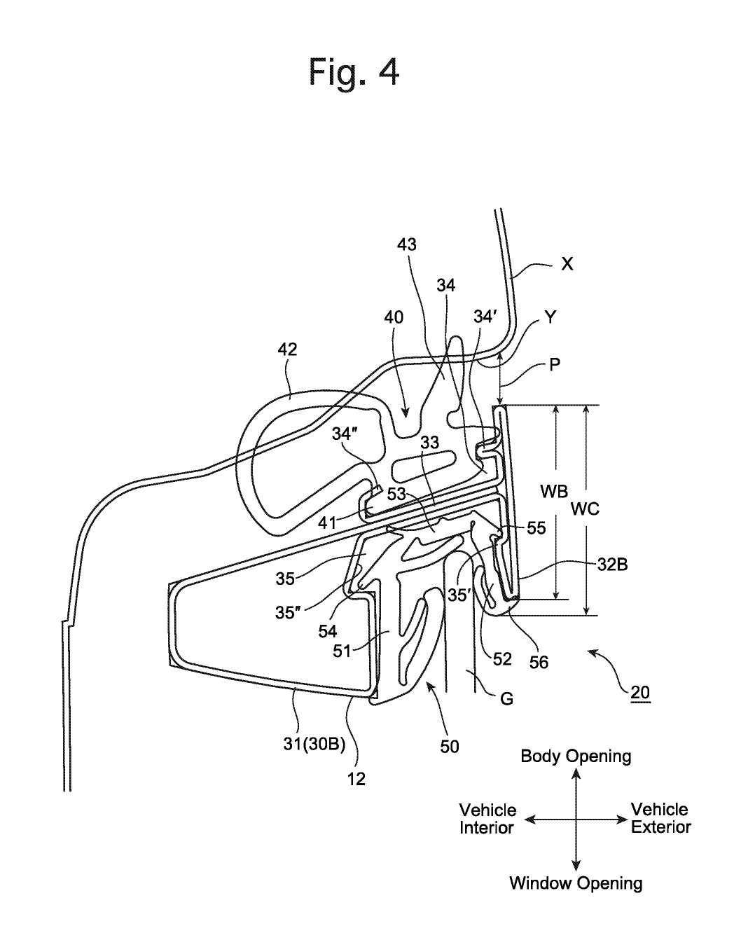

FIGS. 1 through 5 each show a cross sectional view of an embodiment of the vehicle door frame structure according to the present invention, taken along the line II-II shown in FIG. 6, FIGS. 1 and 3 show cross sectional shapes of the first door sash body 30A and the second door sash body 30B, respectively, and FIGS. 2 and 4 show cross sectional shapes thereof together with the peripheries of the first door sash body 30A and the second door sash body 30B, respectively. In FIGS. 1 through 5, the vehicle internal side (inside), the vehicle external side (outside), the body opening side and the window opening side are defined as shown in the drawings.

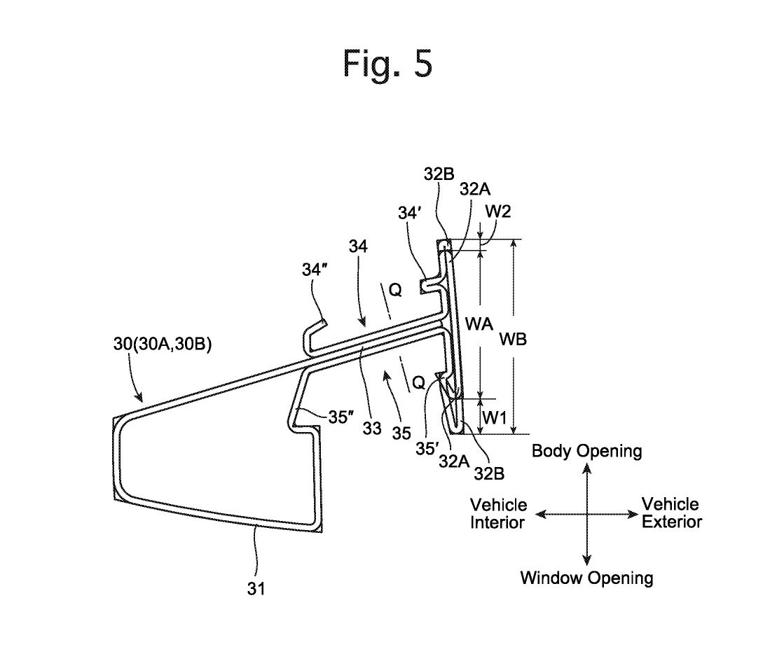

FIG. 2 shows a door sash structure configured of the first door sash body 30A and a lustrous molding (additional molding) 60, and FIG. 4 shows a door sash structure consisting only of the second door sash body 30B (i.e., having no additional molding). As is clearly seen from FIG. 5, in which the first door sash body 30A and the second door sash body 30B are illustrated in a superimposed state, the first door sash body 30A and the second door sash body 30B, which have a uniform cross section in a direction normal to the sheet, are provided with a pocket-shaped portion 31 on the vehicle interior side which bears the strength of the first door sash body 30A and the second door sash body 30B, a design portion 32A or 32B on the vehicle exterior side and a connecting portion 33 which connects the pocket-shaped portion 31 and the design portion 32A or 32B, and are provided on the body opening side and the window opening side of the connecting portion 33 with a weather-strip holding groove 34 and a glass-run holding groove 35, respectively.

The weather-strip holding groove 34 is provided with a folded-back edge 34′ which is formed to project toward the vehicle interior side of the design portion 32A or 32B and a folded-back edge 34″ which is positioned on the connecting portion 33, and the glass-run holding groove 35 is provided with a folded-back edge 35′ which is formed to project toward the vehicle interior side of the design portion 32A or 32B and a depressed portion 35″ which is formed on a part of the pocket-shaped portion 31. As is clearly seen in FIG. 5, of these elements, the pocket-shaped portion 31, the connecting portion 33, the weather-strip holding groove 34 (the folded-back edge 34′ and the folded-back edge 34″) and the glass-run holding groove 35 (the folded-back edge 35′ and the depressed portion 35″) are common in shape between the first door sash body 30A and the second door sash body 30B, and only the shapes of the design portions 32A and 32B are different from each other.

The surfaces of the design portions 32A and 32B on the vehicle exterior side are flat surfaces which extend in the vertical direction (or curved surfaces which are convex toward the vehicle exterior side), and only the widths WA and WB of the design portions 32A and 32B in the vertical direction (the lengths of the widths WA and WB from the window opening side to the body opening side) are different from each other. As can be seen in FIG. 5, the design portion 32A is shorter than the design portion 32B by w1 on the window opening side and shorter than the design portion 32B by w2 on the body opening side. If the shapes of two types of the first and second door sash bodies 30A and 30B are partly commonalized in this manner, the arrangements of roll-forming dies of roll forming machines for roll-forming the first and second door sash bodies 30A and 30B can be partly commonalized, which contributes to cost reduction. Specifically, for instance, it is possible that the group of roll-forming dies for forming the portions on the left-hand side of the line Q-Q shown in FIGS. 1, 3 and 5 be commonalized and that only the group of roll-forming dies for forming the portions on the right-hand side of the line Q-Q shown in FIGS. 1, 3 and 5 be provided individually for the first and second door sash bodies 30A and 30B. The second door sash body 30B is for general type of vehicle, and in the present embodiment, at least the surface of the design portion 32B is colored black by coating or surface treatment.

Rubber weather strips 40 having the same shape are fitted in the weather-strip holding grooves 34 of the first and second door sash bodies 30A and 30B, and rubber glass runs 50 having the same shape are fitted in the glass-run holding grooves 35 of the first and second door sash bodies 30A and 30B. As is commonly known, the weather strips 40 serve to prevent rain water from entering the vehicle by being compressed and deformed between the vehicle door 10 and the body openings Y when the vehicle door 10 is closed, and the weather strips 40 are provided with a fitting portion 41 which is fitted in the weather-strip holding groove 34 and a hollow lip 42 and an elastic lip 43.

As is commonly known, each glass run 50 is elastically deformed upon receiving an edge of the window pane G which moves from a window opening position to the closed position, and is provided with an inner lip 51 which is positioned on the vehicle interior side of the window pane G, an outer lip 52 which is positioned on the vehicle exterior side, and a connecting bottom wall 53 which connects the inner lip 51 and the outer lip 52, so that each glass run 50 has a U-shape cross sectional shape as a whole. The connecting bottom wall 53 is provided on the inner and outer surfaces thereof with locking edges 54 and 55 which are projected to be engaged and locked in the glass-run holding grooves 35 (the folded-back edge 35′ and the depressed portion 35″). The lower end (window-opening side end) of the outer lip 52 projects further toward the window opening side than the design portion 32A (32B) in either case where the glass run 50 is mounted to the first door sash body 30A or the second door sash body 30B, and the vehicle exterior side surface of the lower end of the outer lip 52 constitutes a glass-run exposed portion (design portion) 56.

When a glass run 50 is mounted to the second door sash body 30B, the glass-run exposed portion 56 comes into elastic contact with the end of the design portion 32B on the window opening side to thereby constitute a part of a design surface of the door sash as shown in FIG. 4. Accordingly, the outward appearance of the boundary between the glass-run exposed portion 56 and the design portion 32B appears as a line. The glass runs 50 are made of black rubber, thus harmonizing with the black design portion 32B. The overall width of the design portion of the door sash 20 at this moment is designated by WC which is equal to the overall width WB of the design portion 32B to which the width of the glass-run exposed portion 56 is added.

Whereas, when a glass run 50 is mounted onto the first door sash body 30A, the glass-run exposed portion 56 is covered by the lustrous molding 60 as shown in FIG. 2, thus not being outwardly exposed. The first door sash body 30A and the lustrous molding 60 serve as a combination for use in a luxury vehicle. The lustrous molding 60 is a member having a uniform cross section in a direction normal to the page, and is provided with a molding body 61 made of stainless steel (metal), and an upper-end resin portion 62, a retaining resin portion 63 and a resin molding 64 which are formed to be integral with the metal molding body 61 by extrusion molding. These resin portions 62, 63 and 64 have a degree of freedom in material selection; for instance, play between the door sash body 30A and each of the upper-end resin portion 62 and the retaining resin portion 63 can be reduced by making the upper-end resin portion 62 and the retaining resin portion 63 out of a hard TPO, AES, PVC or the like, while decorativeness of the resin molding portion 64 can be enhanced by making the resin molding portion 64 out of a soft TPO, PVC or the like.

The metal molding body 61 is provided, on the upper end (end on the body opening side) of a design portion (design surface) 61a thereof, with a bent portion 61b and is provided on the lower end (end on the window opening side) of the design portion 61a with a folded-back portion 61c. The upper-end resin portion 62 is provided on the vehicle-interior side end of the bent portion 61b, and the upper-end resin portion 62 is provided at an end (vehicle-interior side end) thereof with a locking flange 62a which projects downward (toward the window opening). The retaining resin portion 63 is provided on the vehicle-interior side end (end of the folded-back portion) of the folded-back portion 61c, and is provided at the vehicle interior side end thereof with an inclined retaining surface 63a which extends along the inner surface of the design portion 32A.

The resin molding portion 64 is provided with an overlaying portion 64a which lies on a lower external surface (on a surface on the vehicle exterior side of the window-opening side end) of the design portion 61a of the metal molding body 61, and a resin design lip portion 64b which extends toward the window opening side from the overlaying portion 64a. The resin design lip portion 64b of the overlaying portion 64a covers the glass-run exposed portion 56 of the glass run 50 so as not to allow the glass-run exposed portion 56 to be exposed. Accordingly, the design portion 61a of the lustrous molding 60, and the overlaying portion 64a and the resin design lip portion 64b of the resin molding portion 64 constitute a design surface of the door sash when the lustrous molding 60 is mounted onto the first door sash body 30A. Additionally, regardless of whether the window pane G is open or closed, the resin design lip portion 64b is in noncontact with the glass-run exposed portion 56 of the glass run 50, so that the glass run 50 does not press (deform) the resin design lip portion 64b, which contributes to maintaining an excellent outward appearance. Additionally, sponges (open-cell forms) 65 which are sandwiched between the first door sash body 30A and the design portion 32A are installed on the rear surface of the metal molding body 61 of the lustrous molding 60 at appropriate intervals in the lengthwise direction of the metal molding body 61 to prevent the metal molding body 61 from being deformed inwardly.

After a glass run 50 is fitted in the glass-run holding groove 35 of the first door sash body 30A, the lustrous molding 60 is mounted to the design portion 32A of the first door sash body 30A as follows. First, in a state where the glass run 50 is fitted in the glass-run holding groove 35 of the first door sash body 30A, a large clearance S exists between the end of the design portion 32A on the window opening side and the glass-run exposed portion 56. In this fitting state of the glass run 50, the upper end of the metal molding body 61 of the lustrous molding 60 is hooked on the upper edge of the design portion 32A. At this stage, the locking flange 62a of the upper-end resin portion 62 enters the vehicle interior side of the upper end the design portion 32A to primarily prevent the lustrous molding 60 from falling from the design portion 32A.

Subsequently, the lustrous molding 60 is rotated clockwise with respect to FIG. 2 about an upper-end engaging portion (the upper-end resin portion 62) to cause the retaining resin portion 63 to be engaged with the lower end of the design portion 32A. Thereupon, the metal molding body 61 is elastically deformed to allow the resin molding portion 64 to enter the back (the vehicle interior side) of the design portion 32A. Thereafter, upon the retaining resin portion 63 temporarily entering the back of the design portion 32A to thereby cause the inclined retaining surface 63a to face the back of the design portion 32A, the end of the inclined retaining surface 63a on the design portion 32A is positioned above the lower end of the design portion 32A, and accordingly, the lustrous molding 60 does not easily come off. In this engaged state of the lustrous molding 60, a clearance “s” is created between the folded-back portion 61c of the metal molding body 61 and the glass-run exposed portion 56, and the resin design lip portion 64b hides the glass-run exposed portion 56.

In a state where the lustrous molding 60 is mounted to the design portion 32A of the first door sash body 30A, the overall width WD of the lustrous molding 60 corresponds to the overall width of the design portion of the door sash 20. The overall width WD of the lustrous molding 60 is equal to or greater than the overall width WC of the design portion consisting of the second door sash body 30B and the glass-run exposed portion 56 (WD≧WC). However, a clearance P between the end of the design portion (the lustrous molding 60) shown in FIG. 2 on the body opening side and the body opening Y and a clearance P between the end of the design portion (the design portion 32A of the second door sash body 30A) shown in FIG. 4 on the body opening side and the body opening Y are maintained the same.

Although the lustrous molding 60 has been illustrated as an additional molding which is mounted to the design portion 32A of the first door sash body 30A in the above illustrated embodiment, the additional molding can be a molding other than a lustrous molding. In addition, although the molding body 61 of the lustrous molding 60 is made of metal, the molding body 61 can also be made of a hard resin.

### INDUSTRIAL APPLICABILITY

The vehicle door frame structure according to the present invention is widely applicable to a plurality of vehicle doors for different specifications.

### REFERENCE SIGN LIST

X Vehicle body
Y Body opening
G Window pane
10 Vehicle door
10F Front door
10R Rear door
11 Door body
12 Window opening
20 Door sash
30A First door sash body
30B Second door sash body
31 Pocket-shaped portion
32A 32B Design portion
33 Connecting portion
34 Weather-strip holding groove
35 Glass-run holding portion
40 Weather strip
41 Fitting portion
42 Hollow lip
43 Elastic lip
50 Glass run
51 Inner lip
52 Outer lip
53 Connecting bottom wall
54 55 Locking edge
56 Glass-run exposed portion
60 Lustrous molding
61a Molding body (Additional molding)
61b Bent portion
61c Folded-back portion
62 Upper-end resin portion
62a Locking flange
63 Retaining resin portion
63a Inclined retaining surface
64 Resin molding portion
64a Overlaying portion
64b Resin design lip portion
65 Sponge (Open-cell form)

1. A door frame structure applicable to a plurality of vehicle doors for different specifications, said door frame structure comprising:
first and second door sash bodies (30A and 30B), in which only design port ions (32A and 32B) thereof are mutually different, said first and second door sash bodies each including a pocket-shaped portion (31), a weather-strip holding groove (34) and a glass-run holding groove (35), wherein said pocket-shaped portion, said weather-strip holding groove and said glass-run holding groove of said first door sash body and said pocket-shaped portion, said weather-strip holding groove and said glass-run holding groove of said second door sash body have a common cross-sectional shape, respectively; and
an additional molding (60) which is mounted onto said design portion of said first door sash body, without being mounted onto said design portion of said second door sash body,
wherein said first door sash body, to which said additional molding is mounted, is used for a door of one specification and said second door sash body is used for a door of another specification.

2. The door frame structure according to claim 1, wherein said design portion of said first door sash body and said design portion of said second door sash body are mutually different in width in cross section.

3. The door frame structure according to claim 1, wherein a clearance between a design portion of said additional molding of said first door sash body and a body opening (Y) and a clearance between said design portion of said second door sash body and said body opening are the same.

4. The door frame structure according to claim 1, wherein said first door sash body, to which said additional molding is mounted, and said second door sash body are used for different specifications of identical vehicle models which have door openings of a same shape.

5. The door frame structure according to claim 1, wherein weather strips (40) having a same cross sectional shape are held in weather-strip holding grooves (34) of said first door sash body and said second door sash body, respectively, and glass runs (50) having a same cross sectional shape are held in glass-run holding grooves (35) of said first door sash body and said second door sash body, respectively.

6. The door frame structure according to claim 5, wherein each of said glass runs comprises an exposed portion (56) which is exposed toward said design portion of said door sash body,
wherein, with respect to said first door sash body, said glass-run exposed portion is spaced from a window-opening side end of said design portion of said first door sash body,
wherein said spacing and a vehicle exterior side surface of said glass-run exposed portion are covered by said additional molding, and
wherein, with respect to said second door sash body, said glass-run exposed portion is in elastic contact with a window-opening side end of said design portion of said second door sash body.

7. A group of vehicles of a same vehicle model in which a door frame structure is applied to a plurality of vehicle doors for different specifications of said same vehicle model, said door frame comprising:
first and second door sash bodies (30A and 30B), in which only design port ions (32A and 32B) thereof are mutually different, said first and second door sash bodies each including a pocket-shaped portion (31), a weather-strip holding groove (34) and a glass-run holding groove (35), wherein said pocket-shaped portion, said weather-strip holding groove and said glass-run holding groove of said first door sash body and said pocket-shaped portion, said weather-strip holding groove and said glass-run holding groove of said second door sash body have a common cross-sectional shape, respectively; and
an additional molding (60) which is mounted onto said design portion of said first door sash body, without being mounted onto said design portion of said second door sash body,
wherein said first door sash body and said additional molding are used for a vehicle door for one specification, and said second door sash body is used for a vehicle door for another specification.
